(19) United States
(12) Patent Application Publication
(10) Pub. No.: US 2015/0286277 A1
(43) Pub. Date: Oct. 8, 2015

(54) WEARABLE TYPE ELECTRONIC DEVICE

(71) Applicant: Samsung Electronics Co., Ltd., Gyeonggi-do (KR)

(72) Inventors: Jae-Hong KIM, Incheon (KR); Jae-Geol Cho, Gyeonggi-do (KR); Jea-Hyuck Lee, Gyeonggi-do (KR)

(73) Assignee: Samsung Electronics Co., Ltd.

(21) Appl. No.: 14/678,204

(22) Filed: Apr. 3, 2015

(30) Foreign Application Priority Data
Apr. 4, 2014 (KR) 10-2014-0040532

(51) Int. Cl. G06F 3/01; G06F 1/16

(52) U.S. Cl. CPC G06F 3/011; G06F 1/163

(57) ABSTRACT

A body-wearable electronic device and a method thereof are provided. The body-wearable device includes including a main body enclosure including a biometric signal sensor; a coupling member extending from the main body enclosure and coupling the main body enclosure to a user's body; and a high-polymer actuator disposed in the coupling member, wherein, as the high-polymer actuator is driven, the biometric signal sensor closely contacts the user's body.

### PRIORITY

This application claims priority under 35 U.S.C. §119(a) to a Korean Patent Application filed in the Korean Intellectual Property Office on Apr. 4, 2014 and assigned Serial number 10-2014-0040532, the entire content of which is incorporated herein by reference.

### BACKGROUND OF THE INVENTION

1. Field of the Invention

The present invention relates generally to an electronic device, and more particularly, to an electronic device a user can wear on the user's body.

2. Description of the Related Art

Electronic devices, which perform specific functions according to embedded programs, range from home appliances to electronic notes, Portable Multimedia Players (PMPs), mobile communication terminals, tablet Personal Computers (PCs), video/audio devices, desktop/laptop computers, vehicle navigation systems, etc. For example, these electronic devices may output stored information in the form of video or audio. Along increasingly high-integration, high-speed, and high-volume wireless communication for electronic devices, various corresponding functions have been provided in individual mobile communication terminals. For instance, some mobile communication terminals provide not only communication functions, but may also provide entertainment functions like games, multimedia functions like music/video playback, communication and security functions for mobile banking, schedule management functions, electronic wallet functions, etc.

A portable electronic device (e.g., an electronic note, a PMP, a mobile communication terminal, a tablet PC, or the like) generally has mounted therein a flat panel display and a battery. An exterior of such a portable electronic device is may be a bar type, a folder type, a slide type, etc. Along with recent developments in electronic communication technologies, electronic devices have been miniaturized. Accordingly, use of electronic devices that may be worn on a body part, such as a wrist or a head, has increased.

Accordingly, there is a need for devices and methods in order to improve functionality increasingly-used wearable electronic devices.

### SUMMARY OF THE INVENTION

The present invention has been made to address at least the above problems and/or disadvantages and to provide at least the advantages described below.

Accordingly, an aspect of the present invention is to provide a body-wearable electronic device including a biometric signal sensor.

Another aspect of the present invention is to provide an electronic device that is easy to manipulate for measurement of a biometric signal while being worn on a body.

Another aspect of the present invention is to provide an electronic device that is easy to switch to a comfortable wearing state in which a user's body is not pressed, after measuring a biometric signal.

According to an aspect of the present invention, a body-wearable electronic device is provided. The body-wearable electronic device includes a main body enclosure including a biometric signal sensor, a coupling member extending from the main body enclosure and coupling the main body enclosure to a user's body, and a high-polymer actuator disposed in the coupling member, wherein, as the high-polymer actuator is driven, the biometric signal sensor closely contacts the user's body.

According to another aspect of the present invention, a method of detecting a biometric signal by a body-wearable device coupled to a user is provided. The method includes detecting, by a pressure sensor, a level of pressure applied by the body-wearable device to the user; providing an electrical signal to a high-polymer actuator included a coupling member that couples the body-wearable device to the user such that the high-polymer actuator expands or contracts the coupling member; and sensing, by the biometric signal sensor, when the high-polymer actuator expands or contracts the coupling member to a predetermined level of pressure, a biometric characteristic of the user.

### BRIEF DESCRIPTION OF THE DRAWINGS

The above and other aspects, features and advantages of the present invention will be more apparent from the following description taken in conjunction with the accompanying drawings, in which:

FIG. 1 is an exploded perspective view diagram illustrating a body-wearable electronic device according to an embodiment of the present invention;

FIG. 2 is a perspective view diagram illustrating a body-wearable electronic device according to an embodiment of the present invention;

FIG. 3 is a side view diagram illustrating a body-wearable electronic device according to an embodiment of the present invention;

FIG. 4 is a cross-sectional view diagram illustrating a body-wearable electronic device according to an embodiment of the present invention;

FIG. 5 is a plan view diagram illustrating a body-wearable electronic device according to an embodiment of the present invention;

FIG. 6 is a bottom view diagram illustrating a body-wearable electronic device according to an embodiment of the present invention;

FIG. 7 is a plan view diagram illustrating a structure in which a high-polymer actuator is disposed in a body-wearable electronic device according to another embodiment of the present invention;

FIG. 8 is a cross-sectional view diagram illustrating a structure in which a high-polymer actuator is disposed in a body-wearable electronic device according to another embodiment of the present invention;

FIG. 9 is a cross-sectional view diagram illustrating an operation of a high-polymer actuator in a body-wearable electronic device according to another embodiment of the present invention;

FIG. 10 is a cross-sectional view diagram illustrating a structure in which a high-polymer actuator is disposed in a body-wearable electronic device according to further another embodiment of the present invention; and

FIG. 11 is a view diagram illustrating a structure in which a high-polymer actuator is disposed in a body-wearable electronic device according to further another embodiment of the present invention.

### DETAILED DESCRIPTION OF EMBODIMENTS OF THE PRESENT INVENTION

Embodiments of the present invention are described herein below with reference to the accompanying drawings. For the purposes of clarity and simplicity, detailed descriptions of well-known functions or configurations may be omitted in order to avoid obscuring the subject matter of the present invention. Terms used herein are defined according to the functions of the present invention. Thus, the terms may vary depending on users' or operators' intentions or practices. Therefore, the terms used herein are to be understood based on the descriptions made herein.

Although embodiments of the present invention can be variously modified, specific embodiments illustrated in the accompanying drawings are primarily described herein. However, the scope of the present invention is not limited to the specific embodiments described herein, and the scope is to be construed as including all the changes, equivalents, and substitutions included in the spirit and scope of the present invention.

Singular expressions such as “unless explicitly indicated otherwise” or “the” include plural expressions. For example, “component surface” may include one or more component surfaces.

Relative terms referred to as illustrated in the drawings, such as a ‘front surface’, a ‘rear surface’, a ‘top surface’, a ‘bottom surface’, and the like, may be replaced with ordinal numbers such as “first”, “second”, etc. The order of components, such as “first”, “second”, and so forth, may be the order in which they are mentioned or an arbitrarily set order, and thus may be changed arbitrarily. The terms, such as “first”, “second”, etc. are used to distinguish one component from another component. For example, a first user device and a second user device indicate different user devices. Also, a first component may be referred to as a second component and likewise, a second component may also be referred to as a first component, without departing from the embodiments of the present invention.

Terms used in various embodiments of the present invention are intended to describe certain embodiments, rather than to limit the various embodiments of the present invention. As used herein, the singular forms are intended to include the plural forms as well, unless the context clearly indicates otherwise. Terms “include” or “may include” used in various embodiments of the present invention indicate an existence of a described function, operation, or element, but do not limit an existence of one or more other functions, operations, or elements. Terms “include” or “has” used in the present invention are intended to indicate an existence of feature, number, step, operation, element, item or any combination thereof, described herein, but do not preclude an existence of (or the possibility of adding) one or more other features, numbers, steps, operations, elements, or any combination thereof.

Unless otherwise defined, all terms (including technical and scientific terms) used herein have the same definition as commonly understood by one of ordinary skill in the art with respect to embodiments of the present invention. It will be further understood that terms, such as those defined in commonly used dictionaries, should be interpreted as having a definition that is consistent with their definition herein with the context of the relevant art as understood by the artisan at the time of invention and will not be interpreted in an idealized or overly formal sense unless expressly so defined herein.

According to an embodiment of the present invention, an electronic device may be a device including a touch panel. The electronic device may be referred to as a terminal, a portable terminal, a mobile terminal, a communication terminal, a portable communication terminal, a portable mobile terminal, a display device, or the like.

For example, the electronic device may be a smartphone, a cellular phone, a navigation system, a game console, a TeleVision (TV), a vehicle head unit, a laptop computer, a tablet computer, a Personal Media Player (PMP), a Personal Digital Assistant (PDA), or the like. The electronic device may be implemented as a pocket-sized portable communication terminal having a wireless communication function. The electronic device may be a flexible device or a flexible display.

The electronic device may communicate with an external electronic device such as a server or operate through interworking with an external electronic device. For example, the electronic device may transmit an image captured by a camera and/or position information detected by a sensor unit to a server over a network. The network may be, but not limited to, a mobile or cellular communication network, a Local Area Network (LAN), a Wireless LAN (WLAN), a Wide Area Network (WAN), Internet, a Small Area Network (SAN), or the like.

According to various embodiments of the present invention, a body-wearable electronic device includes a main body enclosure including a biometric signal sensor, a coupling member extending from the main body enclosure and coupling the main body enclosure to a user's body, and a high-polymer actuator disposed in the coupling member, in which as the high-polymer actuator is driven, the biometric signal sensor closely contacts the user's body.

According to an embodiment of the present invention, the coupling member includes a first band extending from the main body enclosure and having an engagement member installed in an end portion thereof and a second band extending from the main body enclosure and having engagement holes formed corresponding to the engagement member, in which the first band and the second band are engaged with each other to form a ring shape together with the main body enclosure.

According to another embodiment of the present invention, the high-polymer actuator is disposed on the first band in a longitudinal direction.

According to another embodiment of the present invention, the high-polymer actuator has an end fixed to a circuit board received in the main body enclosure and another end fixed in adjacent to the end portion of the first band, and the high-polymer actuator receives an electric signal to contract the first band in the longitudinal direction.

According to another embodiment of the present invention, the first band includes a bellows structure formed in at least a portion thereof, and if an electric signal is applied, the high-polymer actuator may contract the portion of the first band where the bellows structure is formed.

According to another embodiment of the present invention, the portion of the first band where the bellows structure is formed is received in the main body enclosure.

According to another embodiment of the present invention, the body-wearable electronic device further includes a fixing member that passes through the first band in a position adjacent to the end portion of the first band and is coupled with the high-polymer actuator.

According to another embodiment of the present invention, the high-polymer actuator receives an electric signal to reduce a radius of curvature of the first band.

According to another embodiment of the present invention, the body-wearable electronic device further includes a plurality of band members that are arranged in a direction and are coupled displaceably with respect to each other to form the first band.

According to another embodiment of the present invention, the plurality of band members are coupled to move with respect to each other in an arranged direction or to pivot with respect to each other.

According to another embodiment of the present invention, the body-wearable electronic device further includes receiving grooves formed in one surface of the respective band members, in which if the band members are coupled, the receiving grooves are arranged continuously in adjacent to each other to receive the high-polymer actuator.

According to another embodiment of the present invention, the biometric signal sensor may include at least one of a PhotoPlethysmoGraphy (PPG) sensor including a light source and a light-receiving sensor, a Galvanic Skin Reflex (GSR) sensor for detecting a sleep period, and a temperature sensor for measuring a change in a skin temperature.

According to another embodiment of the present invention, the body-wearable electronic device further includes a pressure sensor stacked on the biometric signal sensor, in which the pressure sensor detects whether the biometric signal sensor closely contacts the user's body.

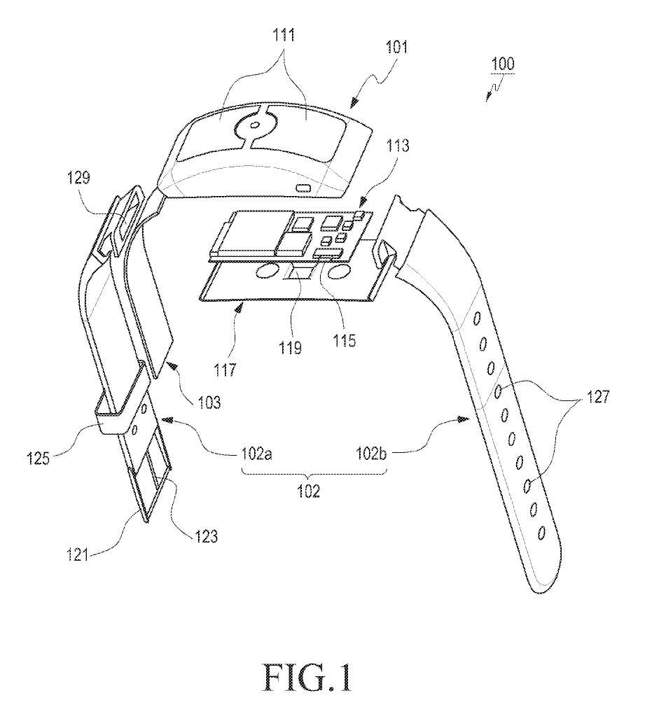

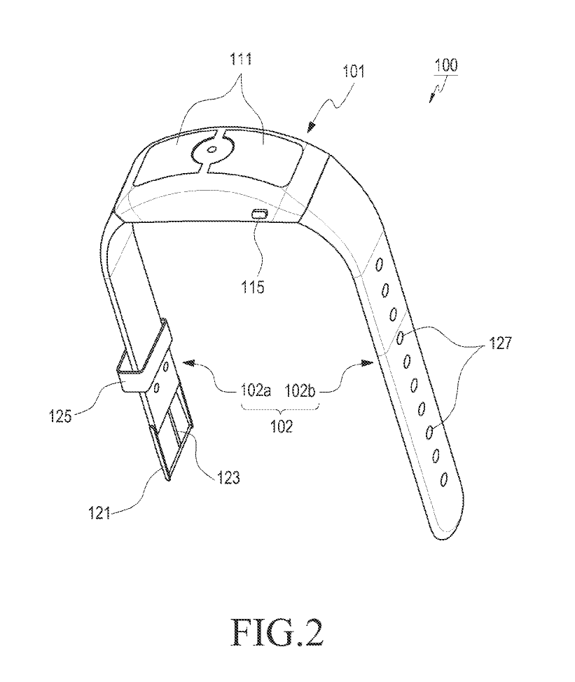

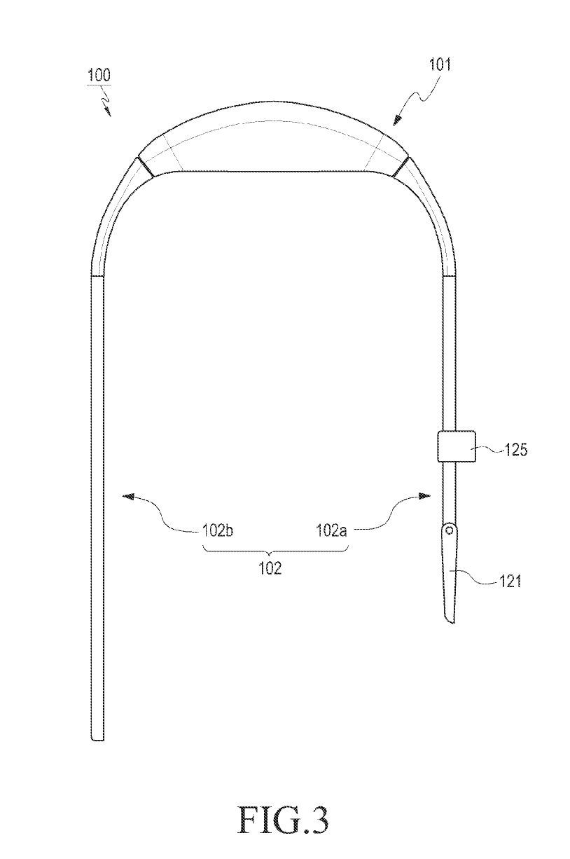

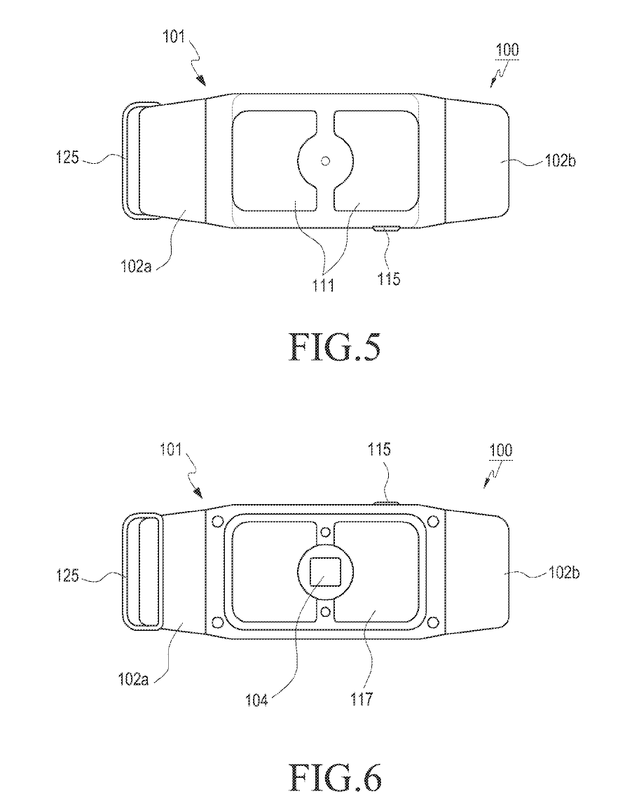

Referring to FIGS. 1 through 6, a body-wearable electronic device 100 according to an embodiment of the present invention includes a main body enclosure 101 including a biometric signal sensor 104, a coupling member 102, and a high-polymer actuator 103. A user wears the electronic device 100 on a body part such as a wrist, by using the coupling member 102. For example, the coupling member 102 extending from the main body enclosure 101 couples the main body enclosure 101 to the user's wrist.

The main body enclosure 101 may include a display 111 installed on a front surface and a circuit board 113 received therein, and a rear surface of the main body enclosure 101 is closed by a cover member 117. The display 111 has a touch panel for use as an input device. According to another embodiment the present invention, the display 111 is substituted for a biometric signal sensor. For example, an electrode pad for measuring a user's heartbeat may be installed on the front surface of the main body enclosure 101. In further another embodiment of the present invention, the electrode pad for sensing a biometric signal may be disposed around the display 111.

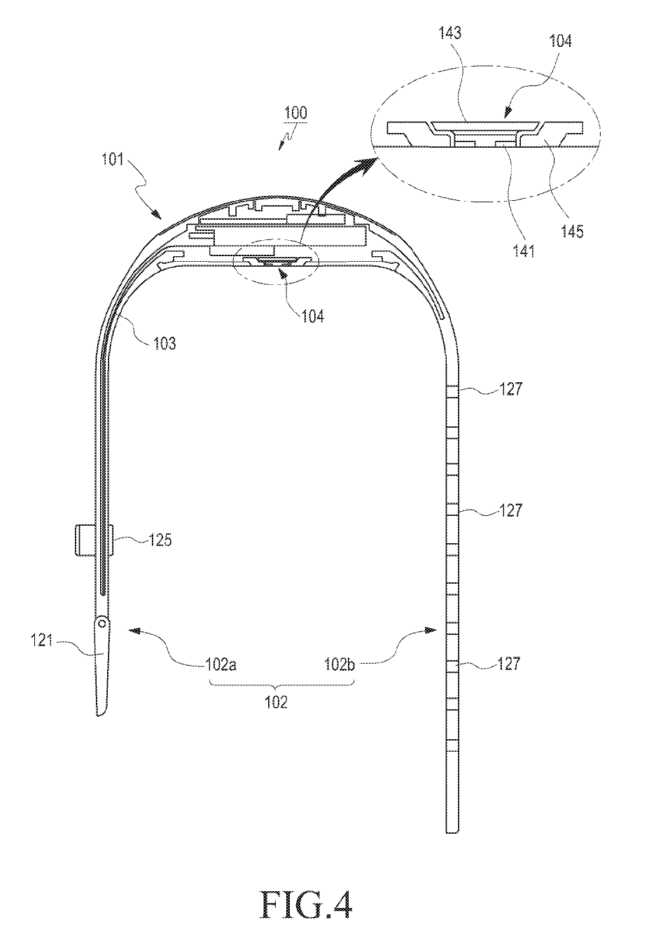

A biometric signal sensor 104 is installed on the circuit board 113, and is exposed to the rear surface of the main body enclosure 101 through an opening 119 formed in the cover member 117. Referring to FIG. 4, the biometric signal sensor 104 is configured with a sensor unit 141 in a module enclosure 145. A pressure sensor 143 is also provided inside the sensor unit 141. For example, the biometric signal sensor 104 is disposed such that it is stacked with the pressure sensor 143. According to another embodiment of the present invention, the biometric signal sensor 104 is mounted on an inner side of the cover member 117, is exposed to the rear surface of the main body enclosure 101 through the opening 119, and is connected to the circuit board 113 through wiring of a flexible printed circuit board or the like. The module enclosure 145 may provide a means for mounting the biometric signal sensor 104 onto the cover member 117.

The biometric signal sensor 104 may include at least one of a PhotoPlethysmoGraphy (PPG) sensor, a Galvanic Skin Reflex (GSR) sensor, and a temperature sensor. The PPG sensor measures pulse waves that express a change in the pressure of a peripheral blood vessel with respect to contraction and relaxation of the heart in the form of waveforms. For example, the PPG sensor may be configured by combining a light source for emitting visible rays or infrared rays with a light-receiving sensor, and may measure pulse waves according to a change in the amount of light absorbed by hemoglobin of the peripheral blood vessel. The GSR sensor detects a user's sleep period and the temperature sensor detects a change in the temperature of the skin of the user. Depending on a configuration of the sensor unit 141, the biometric signal sensor 104 detects various biometric signals of the user.

The coupling member 102 couples the main body enclosure 101 to a user's body. For example, the user wears the electronic device 100 including the main body enclosure 101 on the body by using the coupling member 102. According to an embodiment of the present invention, the coupling member 102 includes a first band 102a and a second band 102b. The first band 102a and the second band 102b extend from the main body enclosure 101 and are coupled to each other, thus forming a ring shape together with the main body enclosure 101. The user wears the electronic device 100 on the user's body (e.g., on the user's wrist) by using the first band 102a and the second band 102b.

First and second engagement members 121 and 123 are installed in an end portion of the first band 102a, and engagement holes 127 corresponding to the first and second engagement members 121 and 123 are formed in the second band 102b. The first and second engagement members 121 and 123 are coupled to the end portion of the first band 102a. The first engagement member 121 is shaped as a frame that allows the second band 102b to pass therethrough. When the second band 102b passes through the first engagement member 121, the second engagement member 123 is engaged with one of the engagement holes 127 and is fixed, such that the first band 102a and the second band 102b form a ring shape together with the main body enclosure 101. A band guide 125 is further provided on the first band 102a. A part of the second band 102b, when it has passed through the first engagement member 121, maintains close contact onto an outer side of the first band 102a due to the band guide 125.

The high-polymer actuator 103 is inserted into the coupling member 102 (e.g., the first band 102a). An insertion hole 129 for receiving the high-polymer actuator 103 is formed in the first band 102a. The insertion hole 129 extends longitudinally from an end portion of the first band 102a. The high-polymer actuator 103 extends longitudinally along the first band 102a so as to be inserted into and fixed in the insertion hole 129. In the present example, an end of the high-polymer actuator 102 is engaged with and fixed onto the circuit board 113 in the main body enclosure 101. As the high-polymer actuator 103 is engaged with and fixed onto the circuit board 113, the high-polymer actuator 103 is provided with an electric signal, such as a voltage from the circuit board 113. The other end of the high-polymer actuator 103 is fixed in adjacent to the end portion of the first band 102a in the insertion hole 129.

The high-polymer actuator 103 is a device functioning as an actuator, which includes a high-polymer material that is transformed by an electric signal. The high-polymer actuator 103 is light-weight, flexible, easily-processed, and is driven by an electric signal, such as a voltage. A driving system for the high-polymer actuator 103 is easily implemented. Examples of high-polymer actuators include a conductive high-polymer actuator, an ionic high-polymer actuator, and so forth, and are suitable for miniaturization, high integration, and low power consumption. Thus, high-polymer actuators are applicable variously in medical/welfare fields, such as robots, artificial muscles, and disease diagnosis in body tissues, and blood vessels.

A conductive high-polymer actuator is a device that causes expansion and contraction based on a change in a structure of a high polymer according to applied voltage and polarity, using a volume change with respect to coming in and out of ions based on oxidation/deoxidization of a conductive high polymer. While generating high level of power, the conductive high-polymer actuator is light-weight and implements a simple driving structure.

The ionic high-polymer actuator uses an ion-exchange resin and electrode assembly, in which contraction and relaxation are performed as cations and anions included in an ionic high-polymer move to a negative (−) pole and a positive (+) pole, respectively, in a given electric field. As the ions move to electrodes having their opposite electric charges, an electrode in which large-volume ions (generally, the cations) are concentrated causes volumetric expansion and an electrode in which small-volume ions (generally, the anions) are concentrated causes volumetric contraction, resulting in bending of the actuator. As transformation occurs due to an external force applied to the ion exchange resin, a density difference is generated due to an expansion/contraction difference. Ions in the ion exchange resin are diffused toward a kidney having a low density, causing maldistribution of electric charges and thus generating an electromotive force. By using such a nature of the ion exchange resin, a displacement sensor or a load sensor may be configured. Accordingly, the ion exchange resin may be used for both a sensor and an actuator. The ionic high-polymer actuator may require liquid (e.g., water) as an ion-carrying medium, and may be stably used also in the air when it is possible to solidify an organic electrolyte solution.

The high-polymer actuator 103 is received in the coupling member 102, for example, in the first band 102a, to contract the first band 102a in a longitudinal direction or to change a radius of curvature of the first band 102a. If the high-polymer actuator 103 operates in the wearing state of the electronic device 100, the first band 102a is contracted or the radius of curvature of the first band 102a is reduced, such that the electronic device 100, for example, the main body enclosure 101 more closely contacts the user's body. As the main body enclosure 101 more closely contacts the user's body, the biometric signal sensor 104 more accurately detects a biometric signal of the user.

Once the high-polymer actuator 103 operates, the first band 102a, the second band 102b, and the main body enclosure 101 closely contact the user's body, increasing a pressure applied to the user's′ body. The pressure sensor 143 senses whether the biometric signal sensor 104 reaches a proper pressure allowing detection of a biometric signal of the user, thus determining a measurement point in time of the biometric signal sensor 104.

When the user wants to check his/her health condition, the high-polymer actuator 103 may be driven. For example, if the user performs biometric signal measurement in a biometric signal measurement mode, the high-polymer actuator 103 operates to urge the main body enclosure 101, for example, the biometric signal sensor 104, to gradually contact the user's body more closely. Biometric signal measurement may be performed by manipulating a key 115 installed on the circuit board 113 and exposed to a side of the main body enclosure 101 or an execution command key implemented on the display 111 having a touch panel integrated therein. Once the high-polymer actuator 103 operates, a pressure sensed by the pressure sensor 143 gradually increases. If the pressure sensor 143 senses that a predetermined pressure is reached, the electronic device 100 stops the operation of the high-polymer actuator 103 and detects a user's biometric signal through the biometric signal sensor 104. After the user's biometric signal is detected, the electronic device 100 blocks a signal applied to the high-polymer actuator 103. If the applied signal is blocked, the high-polymer actuator 103 is restored into an original state and the electronic device 100 switches to a more comfortable wearing state in which the electronic device 100 is not pressed against the user's body in the same manner as during detection of the biometric signal.

If the user wants to stop the biometric signal measurement before completion of the above-described process, the user manipulates the key 115 or a stop key implemented in the display 111 to stop the biometric signal measurement. If the user stops the biometric signal measurement, the signal applied to the high-polymer actuator 103 is blocked and the electronic device 100 switches to the more comfortable wearing state in which the user's body is not pressed in the same manner as during detection of the biometric signal.

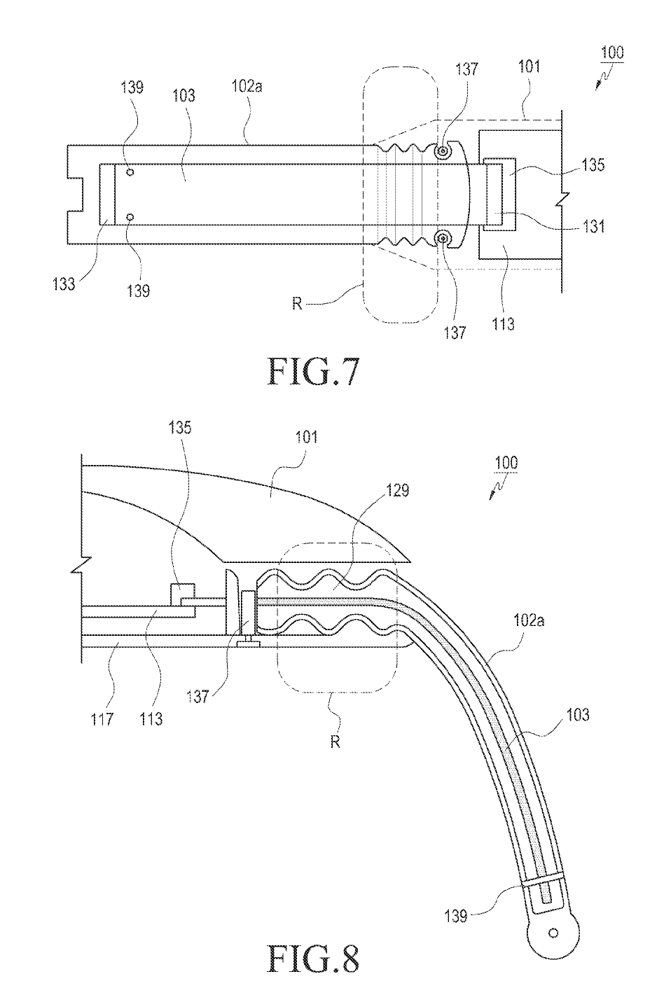

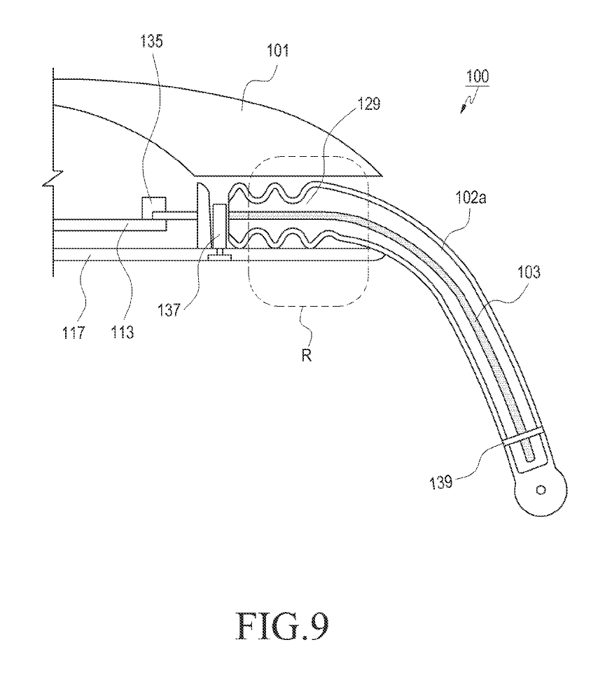

Referring now to FIGS. 7 to 9, an anode (positive-pole) electrode terminal 131 and a cathode (negative-pole) electrode terminal 133 are provided in both ends of the high-polymer actuator 103 and thus are applied with an electric signal from the circuit board 113. In one end of the high-polymer actuator 103, the anode electrode terminal 131 is fixed to a connector 135 provided on the circuit board 113. The connector 135 applies an electric signal to the anode electrode terminal 131 and fixes the one end of the high-polymer actuator 103 to the circuit board 113. The cathode electrode terminal 133 is positioned in adjacent to an end portion of the first band 102a, and is applied with an electric signal from the circuit board 113 through a separate signal wire. In a position adjacent to the end portion of the first band 102a, fixing members 139 such as screws fix the other end of the high-polymer actuator 103 to the first band 102a. The fixing members 139 at least partially passes through the first band 102a in the position adjacent to the end portion of the first band 102a, thus being engaged to the high-polymer actuator 103. One end portion of the first band 102a may be fixed by other fixing members 137 such as other screws or bosses in the main body enclosure 101.

The first band 102a made of a flexible contractible material, such as rubber or silicon. Thus, according to the electric signal applied to the high-polymer actuator 103, the first band 102a is contracted or relaxed, together with the high-polymer actuator 103. In a portion R of the first band 102a, a bellows structure is formed to facilitate contraction/relaxation. The portion R of the first band 102a in which the bellows structure is formed may be received in the main body enclosure 101. As the high-polymer actuator 103 operates, the portion R of the first band 102a in which the bellows structure is formed is contracted or relaxed in the main body enclosure 101, changing the length of the first band 102a. The high-polymer actuator 103, which changes the length of the first band 102a, may be implemented with a conductive high-polymer actuator, and as shown in FIG. 7, the electrode terminals 131 and 133 may be provided in the both ends of the high-polymer actuator 103, respectively.

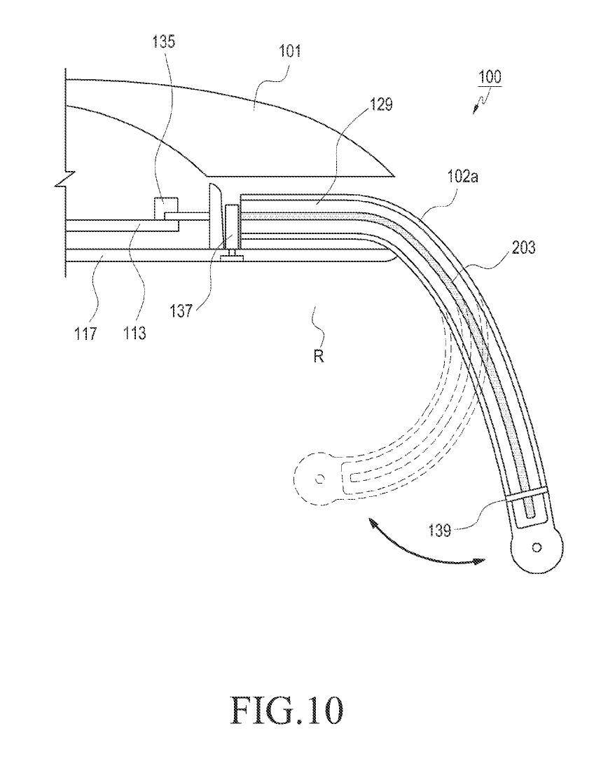

Referring to FIG. 10, structures according to the embodiment illustrated in FIG. 10 that are easily understood from the above-described embodiments are referred to with identical reference numerals as the above-described embodiments, or reference numerals of these structures may be omitted and a further description thereof may also be omitted for clarity and conciseness.

A high-polymer actuator 203 of the body-wearable electronic device 100 illustrated in FIG. 10 may be implemented with an ionic high-polymer actuator. The ionic high-polymer actuator is applied with a positive-pole electric signal and a negative-pole electric signal on both surfaces thereof, thus undergoing a change in the radius of curvature thereof. An end of the high-polymer actuator 203 is fixed to the circuit board 113 and the other end thereof is fixed to a position adjacent to an end portion of the first band 102a. The first band 102a may be made of a flexible material (e.g., a synthetic resin, such as rubber or silicon).

An end of the high-polymer actuator 103 is fixed to the connector 135 of the circuit board 113 to receive an electric signal from the circuit board 113. The connector 135 applies the positive-pole electric signal and the negative-pole electric signal to the both surfaces of the high-polymer actuator 203, respectively. The high-polymer actuator 203 having received the electric signals is transformed into a shape having a smaller radius of curvature. As the radius of curvature of the high-polymer actuator 203 decreases, the main body enclosure 101 of the electronic device 100, for example more closely contacts the user's body. If the pressure sensor 143 senses that a predetermined pressure is reached as the main body enclosure 101 gradually contacts the user's body more closely, then the electronic device 100 detects the user's biometric signal through the biometric signal sensor 104.

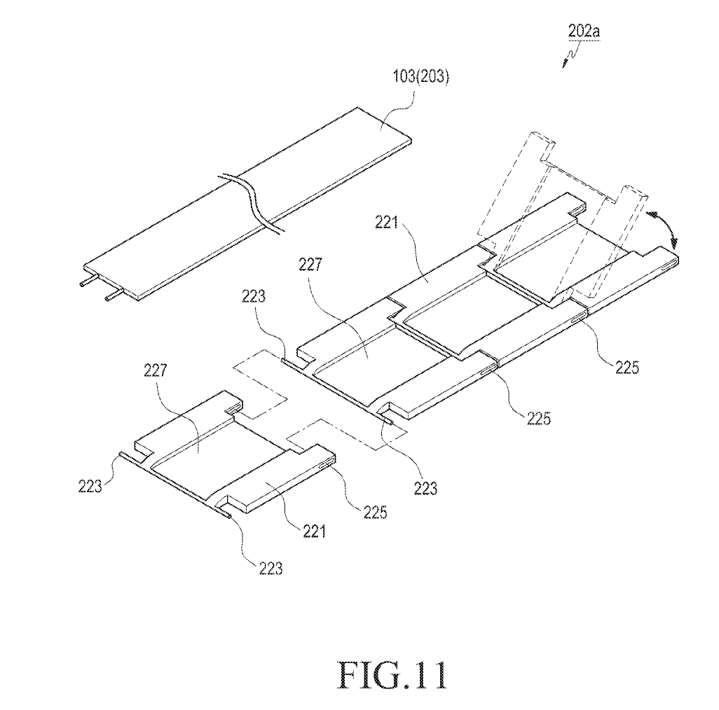

Referring to FIG. 11, the electronic device 100 includes multiple band members 221 and a first band 202a may be formed by coupling the band members 221. The band members 221 are arranged in a direction and are coupled in a manner that allows the band members 221 to be displaced with respect to each other. For example, the band members 221 may be coupled to linearly move with respect to each other in the arranged direction or to pivot with respect to each other.

Each band member 221 include a coupling pin 223 formed in an end thereof and a coupling hole 225 in the other end thereof. The coupling pin 223 is coupled to rotate with respect to a coupling hole 225 of another adjacent band member 221. As the coupling pin 223 is rotatably coupled to the coupling hole 225 of the another adjacent band member 221, the band members 221 can pivot with respect to each other. The coupling hole 225 is formed as an elongated hole extending in the arranged direction of the band members 21. Therefore, the coupling hole 225 allows the band members 221 may move linearly in an arranged direction, and can pivot with respect to their adjacent band members 221. To facilitate an assembly process, the coupling pin 223 may have a pogo pin structure.

A receiving groove 227 is formed in at least one surface of each band member 221. When the band members 221 are coupled, the receiving grooves 227 are continuously arranged in adjacent to each other to receive the high-polymer actuators 103 and 203. As the band members 221 move linearly with respect to each other, the length of the first band 202a is controlled, and as the band members 221 pivot with respect to each other, the radius of curvature of the first band 202a is controlled. The first band 202a may be transformed into another form, depending on the high-polymer actuators 103 and 203 disposed in the receiving groove 227. For example, if the conductive high-polymer actuator is disposed in the receiving groove 227, the first band 202a may be longitudinally contracted and relaxed; if the ionic high-polymer actuator is disposed, the radius of curvature of the first band 202a may be controlled.

When the biometric signal is measured using the electronic device worn on the user's body, the measurement is performed more accurately by making the biometric signal sensor and the user's body contact closely to each other. Thus, the user is not required to undergo the cumbersome process of manually adjusting the coupling member to make the biometric signal sensor closely contact the user's body. Instead, a body-wearable electronic device according to various embodiments of the present invention adjusts the length or radius of curvature of the coupling member by using the high-polymer actuator, enabling the user to more conveniently measure the biometric signal while wearing the electronic device.

An electronic device according to various embodiments of the present invention is wearable on the body and includes the biometric signal sensor, thus measuring or predicting the user's health condition by detecting, for example, the PPG, the sleep period, the skin temperature, the heartbeat, and so forth of the user. An electronic device according to various embodiments of the present invention drives the high-polymer actuator through simple manipulation when the user wears the electronic device, thus closely contacting the user's body and easily measuring the biometric signal of the user. Moreover, through simple manipulation after completion of the measurement, the electronic device switches to a more comfortable wearing state in which the electronic device does not press the user's body.

Other effects that may be acquired or expected from the embodiments of the present invention are explicitly or implicitly described herein. For example, various effects expected from embodiments of the present invention have been described herein.

Embodiments of the present invention shown and described herein merely provide particular examples to easily describe the technical contents of the present invention and to facilitate understanding of the present invention, rather than to limit the scope of the embodiments of the present invention. Thus, embodiments of the present invention include any changes or modifications derived from the technical spirit of the embodiments of the present invention as well as the embodiments described herein. For example, in the above-described embodiments, while it has been described that the high-polymer actuator is disposed in the first band, the high-polymer actuator may also be disposed in the second band.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A body-wearable electronic device comprising:
a main body enclosure comprising a biometric signal sensor;
a coupling member extending from the main body enclosure and coupling the main body enclosure to a user's body; and
a high-polymer actuator disposed in the coupling member,
wherein, as the high-polymer actuator is driven, the biometric signal sensor closely contacts the user's body.

2. The body-wearable electronic device of claim 1, wherein the coupling member comprises:
a first band extending from the main body enclosure and having an engagement member installed in an end portion thereof; and
a second band extending from the main body enclosure and having engagement holes formed corresponding to the engagement member,
wherein the first band and the second band are engaged with each other to form a ring shape together with the main body enclosure.

3. The body-wearable electronic device of claim 2, wherein the high-polymer actuator is disposed on the first band in a longitudinal direction of the first band.

4. The body-wearable electronic device of claim 3, wherein an end of the high-polymer actuator is fixed to a circuit board received in the main body enclosure and another end of the high-polymer actuator is fixed adjacent to the end portion of the first band, and the high-polymer actuator contracts the first band in the longitudinal direction when an electrical signal is applied to the high-polymer actuator.

5. The body-wearable electronic device of claim 4, wherein the first band comprises a bellows structure formed in at least a portion of the first band, and when the electric signal is applied to the high-polymer actuator, the high-polymer actuator contracts the portion of the first band where the bellows structure is formed.

6. The body-wearable electronic device of claim 5, wherein the portion of the first band where the bellows structure is formed is received in the main body enclosure.

7. The body-wearable electronic device of claim 4, further comprising a fixing member that passes through the first band in a position adjacent to the end portion of the first band and is coupled with the high-polymer actuator.

8. The body-wearable electronic device of claim 3, wherein the high-polymer actuator reduces a radius of curvature of the first band when an electrical signal is applied to the high-polymer actuator.

9. The body-wearable electronic device of claim 3, wherein the coupling member further comprises a plurality of band members that are arranged in a direction and are coupled displaceably with respect to each other to form the first band.

10. The body-wearable electronic device of claim 9, wherein the plurality of band members are coupled to at least one of:
move with respect to each other in an arranged direction, and
pivot with respect to each other.

11. The body-wearable electronic device of claim 9, wherein the coupling member further comprises:
receiving grooves formed in one respective surface of each of the plurality of band members,
wherein the receiving grooves are arranged continuously in adjacent to each other to receive the high-polymer actuator.

12. The body-wearable electronic device of claim 1, wherein the biometric signal sensor comprises at least one of a PhotoPlethysmoGraphy (PPG) sensor comprising a light source and a light-receiving sensor, a Galvanic Skin Reflex (GSR) sensor for detecting a sleep period, and a temperature sensor for measuring a change in a skin temperature.

13. The body-wearable electronic device of claim 1, further comprising a pressure sensor stacked on the biometric signal sensor,
wherein the pressure sensor detects whether the biometric signal sensor closely contacts the user's body.

14. A method of detecting a biometric signal by a body-wearable device coupled to a user, the method comprising:
detecting, by a pressure sensor, a level of pressure applied by the body-wearable device to the user;
providing an electrical signal to a high-polymer actuator included a coupling member that couples the body-wearable device to the user such that the high-polymer actuator expands or contracts the coupling member; and
sensing, by the biometric signal sensor, when the high-polymer actuator expands or contracts the coupling member to a predetermined level of pressure, a biometric characteristic of the user.

15. The method of claim 14, wherein the coupling member includes a first band extending from the main body enclosure and having an engagement member installed in an end portion thereof, and further includes a second band extending from the main body enclosure and having engagement holes formed corresponding to the engagement member, and
wherein the first band and the second band are engaged with each other to form a ring shape together with the main body enclosure.

16. The method of claim 15, wherein the high-polymer actuator is disposed on the first band in a longitudinal direction of the first band.

17. The method of claim 16, wherein the first band includes a bellows structure formed in at least a portion of the coupling member, and wherein the high-polymer actuator expands or contracts the portion of the first band where the bellows structure is formed.

18. The method of claim 16, wherein the high-polymer actuator reduces a radius of curvature of the first band when an electrical signal is applied to the high-polymer actuator.

19. The method of claim 14, wherein the coupling member further includes a plurality of band members that are arranged in a direction and are coupled displaceably with respect to each other to form the first band, and
wherein the plurality of band members are coupled to at least one of:
move with respect to each other in an arranged direction, and
pivot with respect to each other.

20. The method of claim 14, wherein the biometric signal sensor includes at least one of a PhotoPlethysmoGraphy (PPG) sensor comprising a light source and a light-receiving sensor, a Galvanic Skin Reflex (GSR) sensor for detecting a sleep period, and a temperature sensor for measuring a change in a skin temperature.
